(19) United States
(12) Patent Application Publication
(10) Pub. No.: US 2025/0105376 A1
(43) Pub. Date: Mar. 27, 2025

(54) ELECTRIC VEHICLE POWER AND CONTROL SYSTEM

(71) Applicant: Wingard Motorsports, LLC, Annapolis, MD (US)

(72) Inventor: Robert Wingard, Annapolis, MD (US)

(21) Appl. No.: 18/898,543

(22) Filed: Sep. 26, 2024

Related U.S. Application Data
(60) Provisional application No. 63/585,407, filed on Sep. 26, 2023.

(51) Int. Cl. H01M 10/42; B60L 58/22; B60L 58/26; H01M 10/48; H01M 50/249; H01M 50/298

(52) U.S. Cl. CPC H01M 10/425; B60L 58/22; B60L 58/26; H01M 10/486; H01M 50/249; H01M 50/298; B60L 2250/16; H01M 2220/20

(57) ABSTRACT

An electric vehicle power and control system includes an electronic control unit, a battery management system (BMS), a power control and distribution box, and a battery module housing system. The electronic control unit includes a computer having dual CAN bus interfaces. It is configured to interface with a touch screen monitor having a six degrees of freedom inertial measurement unit. The battery management system includes a base unit and a plurality of stack units configured for battery cell balancing and monitoring cell voltage and temperature. The power control and distribution box includes bus bars to connect at least one of fuses, contactors, a smart pre-charger, and isolation and current monitors. The battery module housing system includes battery cells integrated with at least one of the battery management system plurality of stack units.

### BACKGROUND

The present disclosure relates to an electric vehicle (EV) power and control system, and more particularly to an electric vehicle system having an electronic control unit, battery management system, power control and distribution system, and battery module housing system.

Electric vehicle power and control systems are well known in the industry. However, there is a need for such systems to charge more efficiently and effectively and to provide power with increased capacity and control.

### SUMMARY OF THE INVENTION

Accordingly, it is an object of the present disclosure to provide an electric vehicle power and control system that includes an electronic control unit, a battery management system (BMS), a power control and distribution box, and a battery module housing system. The electronic control unit includes a computer having dual CAN bus interfaces. It is configured to interface with a touch screen monitor having a six degrees of freedom inertial measurement unit. The battery management system includes a base unit and a plurality of stack units configured for battery cell balancing and monitoring cell voltage and temperature. The power control and distribution box includes bus bars to connect at least one of fuses, contactors, a smart pre-charger, and isolation and current monitors. The battery module housing system includes battery cells integrated with at least one of the battery management system plurality of stack units.

In one embodiment, the computer is an industrial grade computer further including ARM/X64 CPU, 4 GB RAM, 1 TB SSD, USB, WIFI, and Bluetooth.

In another embodiment, the battery management system base unit is connected to the plurality of stack units via a daisy chain wiring harness. It communicates via CAN bus and direct wires with at least one of cooling pumps, the power control and distribution box, a combined charging unit, a charging port, a motor drive system, and door lock system.

Preferably, the power control and distribution box includes high voltage bus bars and implements high voltage connectors for a battery pack, motor drive unit, and high voltage accessories of an electric vehicle.

In another embodiment, the battery module housing system battery cells are in a default 74P6S configuration.

The battery module housing system preferably includes high voltage bus bar piping for cooling fluid in a billet aluminum and composite carbon fiber chassis. One to eight battery modules with a battery management system stack communication harness are also included. The high voltage bus bars and cooling fluid piping are included and connected in a daisy chain configuration.

In yet another embodiment, a high voltage connector for positive and negative terminals of the system and a low voltage connector for battery management system stack communications are also included. Preferably, two cooling fluid ports are included for separate intake and outlet. Further similar embodiments are described below.

The electronic control unit includes an industrial grade computer with ARM/X64 CPU, 4 GB RAM, 1 TB SSD, USB, WIFI, Bluetooth and dual CAN bus interfaces. The computer will interface to 10 inch or larger touch screen monitor, GPS, 6 DOF inertial measurement unit (IMU). The computer is preferably configured with Linux as the operating system and installed with proprietary electronic control unit software developed using QT.

The battery management system includes a BMS base unit and up to 63 stack units for battery cell balancing and monitoring of cell voltages and temperature. The BMS base unit is connected to the stack units using a daisy chain wiring harness similar to Tesla's existing cables harness. The BMS base unit will interface to the cooling pumps, power control and distribution box, combined charging unit, J1772 charging port, motor drive system and door lock system through CAN bus and direct wire interface.

The power control and distribution box includes high voltage bus bars to connect high voltage fuses, high voltage contactors, smart pre-charger, isolation and current monitors. The power control and distribution box will also implement high voltage connectors for interfacing to the EV's 400V battery pack, motor drive unit, high voltage accessories (air conditioner and heater).

The battery module housing system includes battery cells in a default 74P6S configuration integrated with a BMS stack unit, high voltage bus bars piping for cooling fluid installed inside custom chassis machined from billet aluminum and composite carbon fiber. Each battery housing system will consist of between one to eight battery modules with BMS stack communication harness, high voltage buss bars and cooling fluid piping connected in a daisy chain configuration. A high voltage IP67 rated connector will be installed for the overall system positive and negative terminals. A separate low voltage IP67 connector will be used for BMS stack communications. Two cooling fluid ports will be installed for intake and outlet separately.

### BRIEF DESCRIPTION OF THE DRAWINGS

Other objects and advantages of the disclosure will become apparent from a study of the following specification when viewed in the light of the accompanying drawing, in which:

FIG. 1 is a block diagram of an electric vehicle power and control system according to the present disclosure;

FIG. 2 is a block diagram of components of the system of FIG. 1;

FIGS. 3-10 are graphical user interfaces according to the present disclosure;

FIG. 11 is a block diagram of a vehicle dashboard system according to the present disclosure;

FIG. 12 is a block diagram of a vehicle motor drive system according to the present disclosure;

FIG. 13 is an embodiment of a Tesla battery management system card;

FIG. 14a is a front view of a cell back unit card according to the present disclosure;

FIG. 14b is a front view of the card of FIG. 14a installed in battery modules.

FIG. 14c is a partial top perspective view of battery modules according to the present disclosure;

FIG. 15 is a block diagram of the elements of a vehicle power system according to the present disclosure;

FIG. 16 is a block diagram of an isolated daisy chain for support of cell pack units according to the present disclosure;

FIGS. 17-19 are perspective views of an electric vehicle power source controller and distribution unit according to the present disclosure;

FIG. 20 is a circuit diagram of the source controller and distribution unit of FIGS. 17-19;

FIG. 21 is a block diagram of the elements of a high voltage control box according to the present disclosure;

FIGS. 22-27 are front perspective, rear perspective, side, bottom, front, and rear views, respectively, of a battery module housing according to the present disclosure;

FIG. 28 is a perspective view of an interior of a battery module housing with stackable compartments according to the present disclosure;

FIG. 29 is a partial view of the battery connector of FIG. 28; and

FIGS. 30 and 31 are front and perspective views, respectively, of a stackable battery module according to the present disclosure.

### DETAILED DESCRIPTION

The present disclosure relates to an electric vehicle (EV) system, which uses novel components in combination with commercial off the shelf (COTS) or third-party components where needed and available.

There are design customizations available, including with a touch screen system that utilize software and machine-readable code allowing the control system to consolidate monitoring and controls across most COTS & third-party hardware. The system is thus adaptable to many products.

There is a battery management system that includes 400V EV Lithium battery monitoring and charging control, 400V EV balancing, programable active end of charge and passive battery cell balancing, and 12V lead acid battery monitoring and charging control. These prevent battery damage from over charging and over discharge and result in reduced system complexity and wiring to CAN bus, verse point to point, for improved safety and ease of assembly, along with reduced quiescent power consumption and extended storage time from weeks to months.

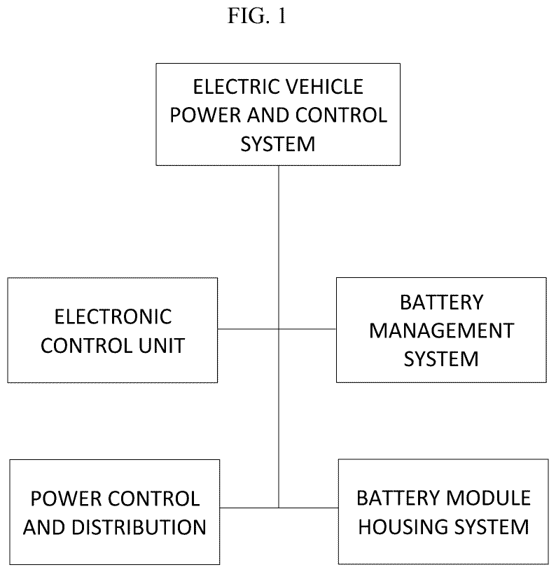

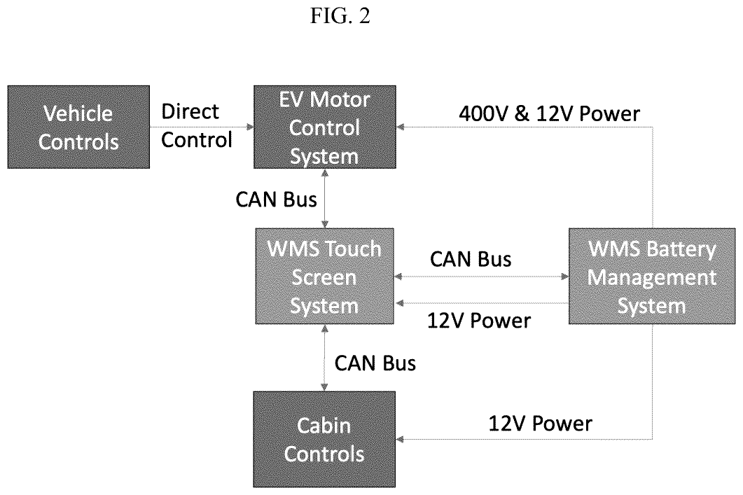

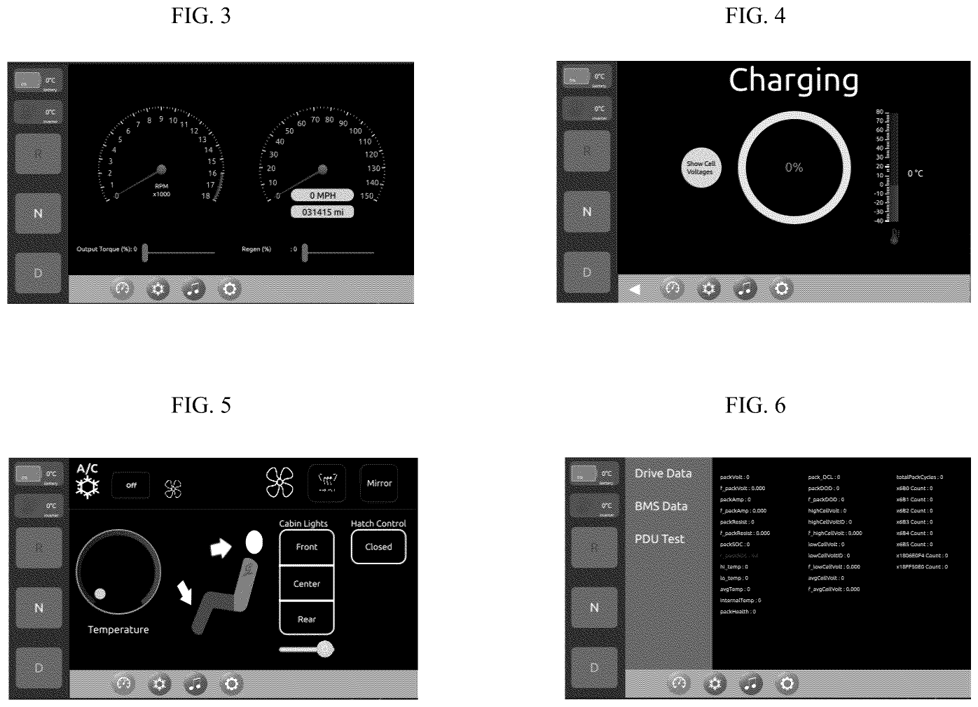

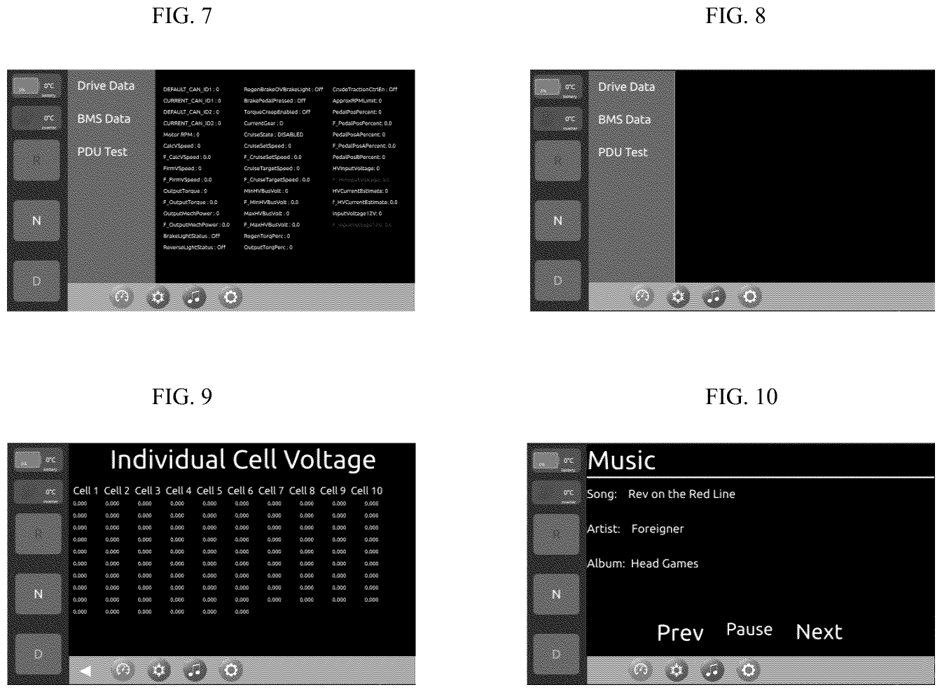

FIG. 1 shows a block diagram for a master electronic control unit (ECU) with touchscreen interface, which is cross platform configurable, allowing it to work with most aftermarket controls, as well as the battery management system, battery chargers, motors, switch gear and systems disclosed herein. The ECU interfaces with CAN bus controller for all EV operations, including security, power on, drive, cabin function, battery status and changer management, motor drive options, forward, reverse, park, regeneration, performance modes, heating and air conditioner setting, light functions, phone interfaces, Wi-Fi interface and Bluetooth, and drive alerts for battery functions and failures.

There is an always-on driver console which allows gear change, displays battery state of charge, battery temperature, inverter temperature and motor temperature. A multifunction display area includes cabin controls, battery management, car management and debugging, car audio controls, and Bluetooth pairing screen.

A menu control bar allows quick switching between primary screens such as the dashboard, cabin controls, music, and settings. The unit includes speed and RPM, allows changing of output torque limits and regen, output torque and regen sliders.

There is a touch screen system that includes an industrial grade CPU/computer with touch screen having, (1) a CAN bus interface to motor control system, battery management system, and cabin controls, (2) GPS and 6 degree of freedom (6DOF) inertial measurement unit (IMU) data logging, and (3) 1 terabyte (TB) solid state drive (SSD) vehicle data storage. This is customizable to support additional third-party systems. The preferred software includes the Linux operating system and C/C++ with QT for the user interface. The software is designed to be portable between ARM and x64 systems. Vehicle telemetry can be downloaded via WIFI.

The touch screen system provides improvements over known systems as follows. Most existing systems are vendor specific or not easily customizable to support third party motor control or BMS systems. The system supports a 10″ or bigger touch screen. Except for original equipment manufacturer (OEM) systems which are not available on the open market, most touch screen systems for vehicle are 7″ or below. The system allows for monitoring of motor control, BMS, charging and cabin controls. With the exception of OEM systems, most existing systems on the open market implement speedometer functionality only. Software developed in C/C++ with QT can be recompiled to support other hardware architecture for upgrades. There are integrated data logging capability.

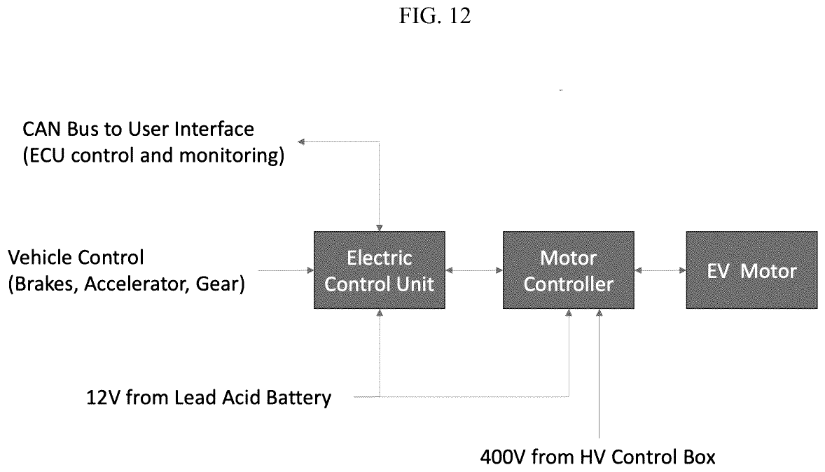

Referring to FIG. 12, there is a motor control system, which uses COTS/third party vehicle controls such as steering, accelerator, brakes, and turn signals. The motor control system includes numerous electric control systems, such as AEMEV VCU200, O57 motor controller, a general purpose vehicle control unit, and interfaces to most CAN bus-controlled hardware, a motor controller, which includes AEMEV LDU—with VCU200, VCU300, Tesla—with O57, Cascadia, general purpose vehicle control unit with most CAN bus-controlled hardware, and a motor, which preferably includes a Tesla Model S single or dual electric motor and most CAN bus controller motors.

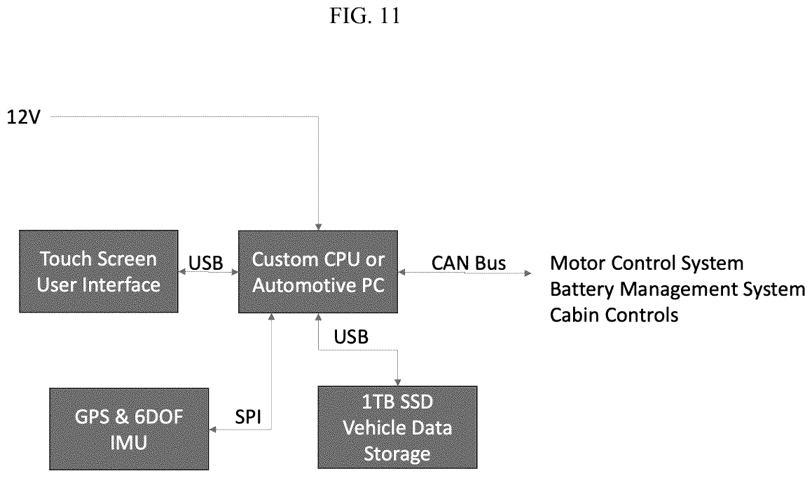

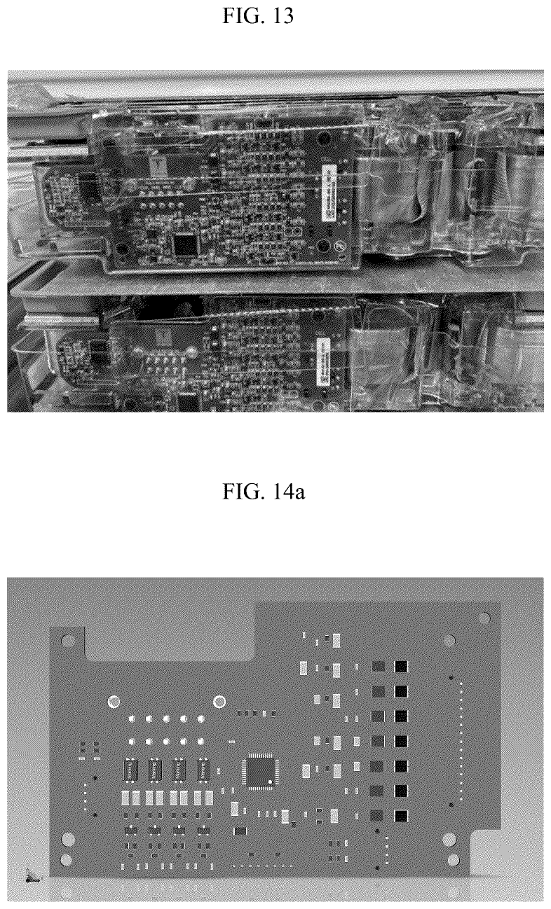

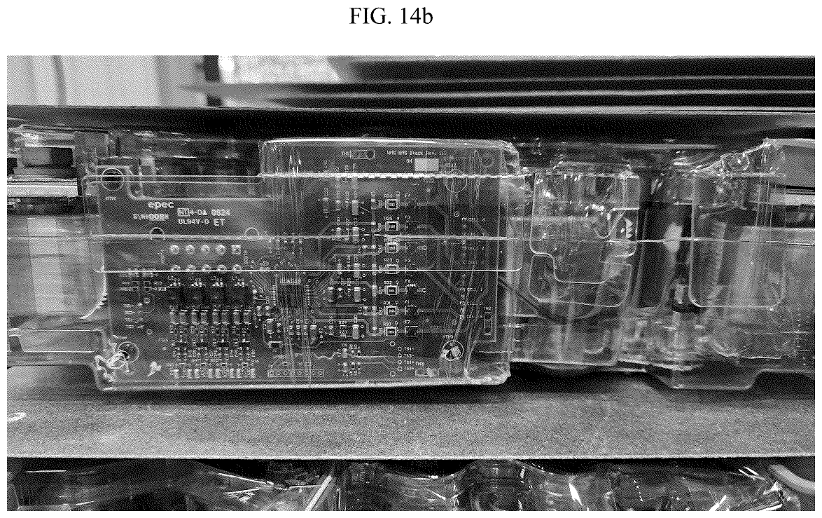

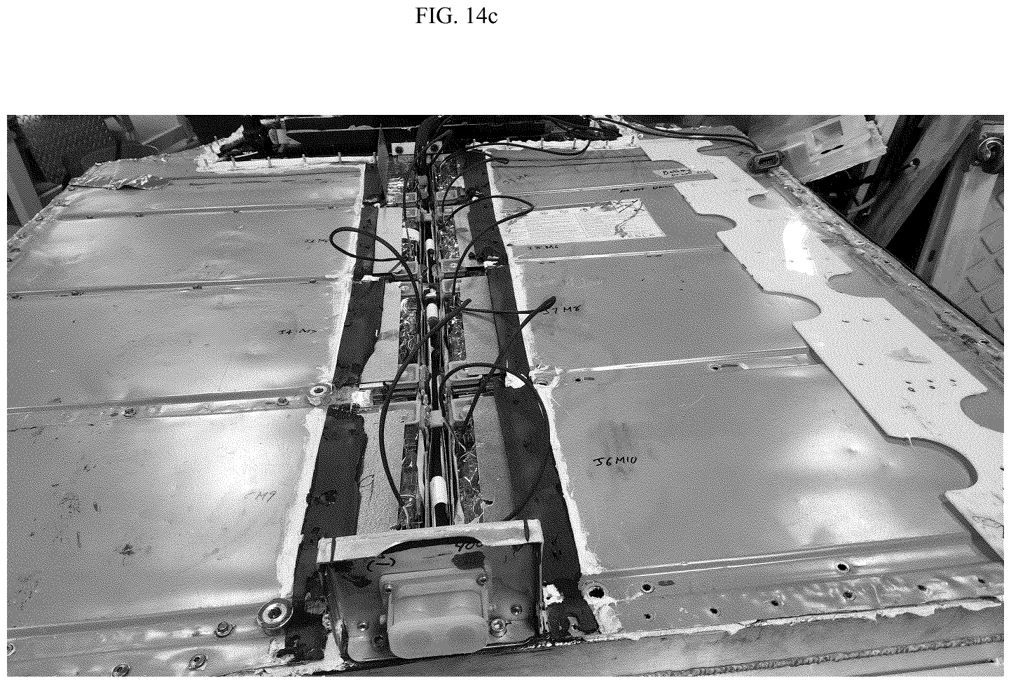

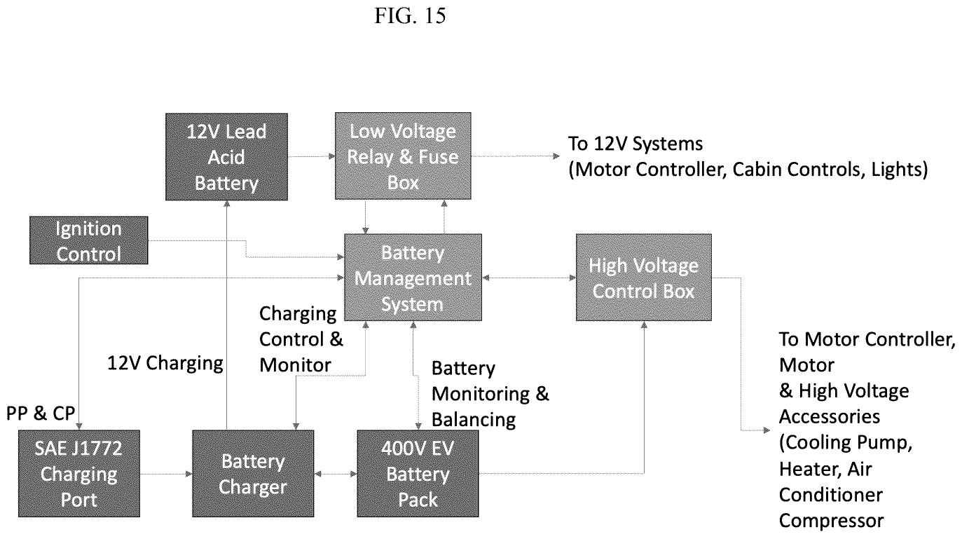

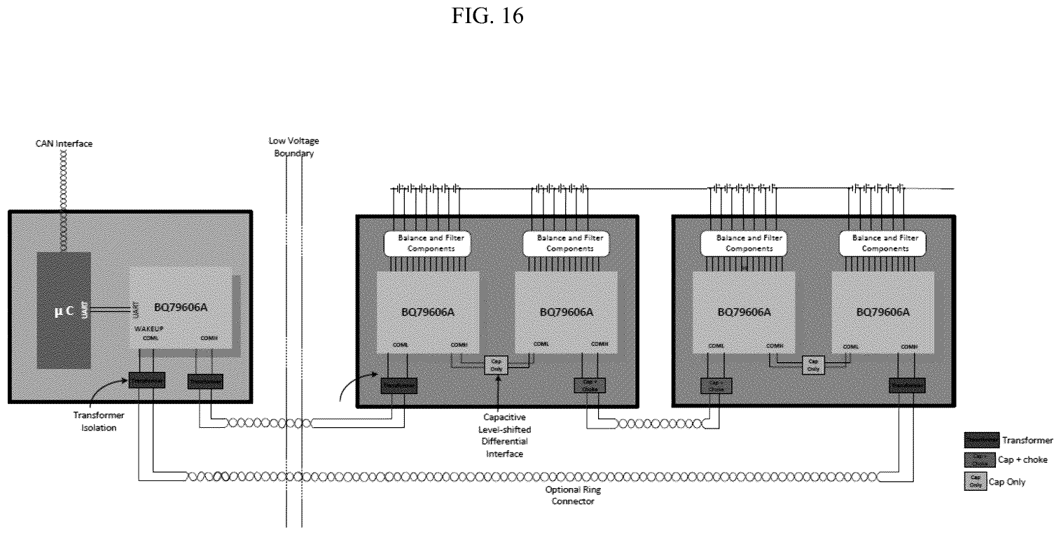

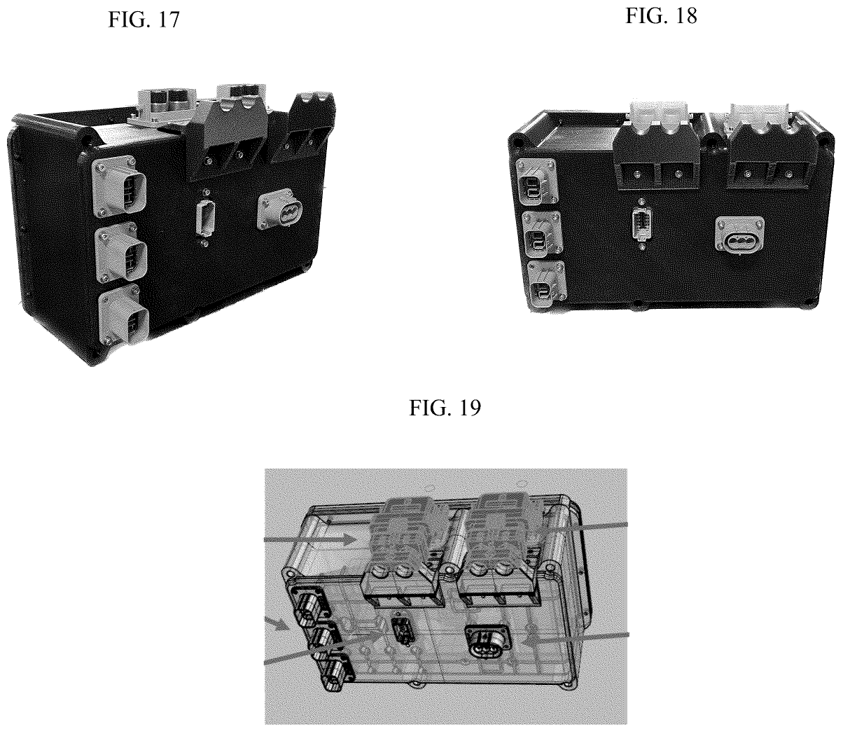

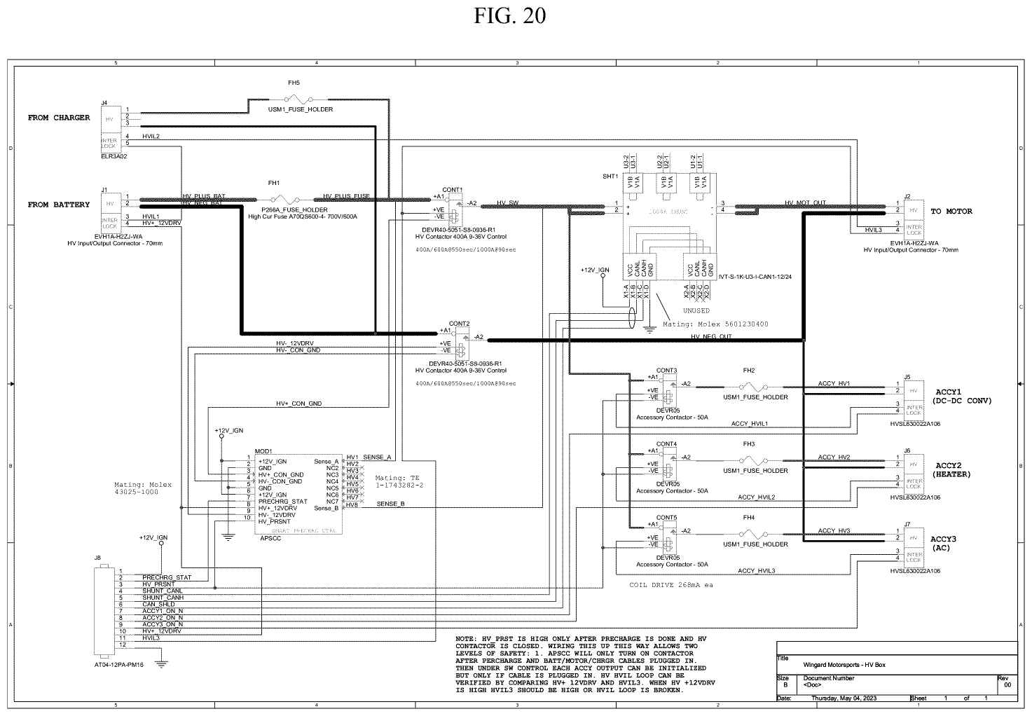

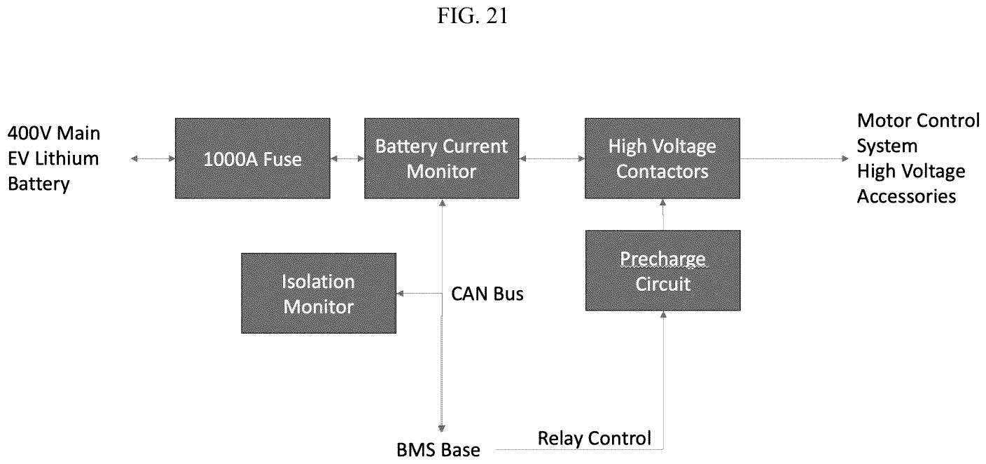

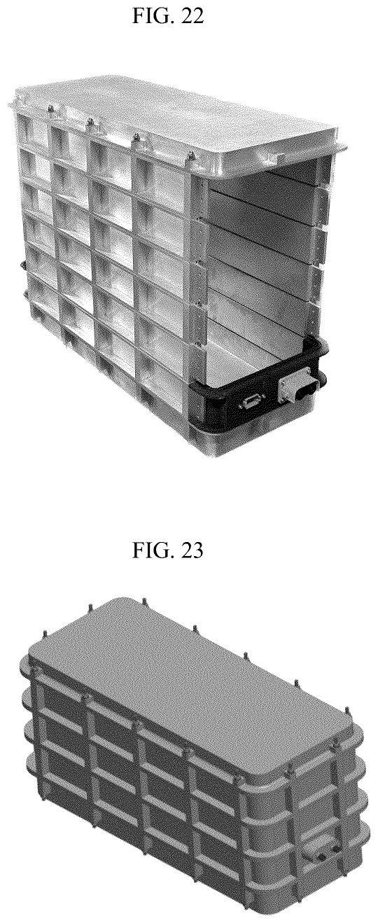

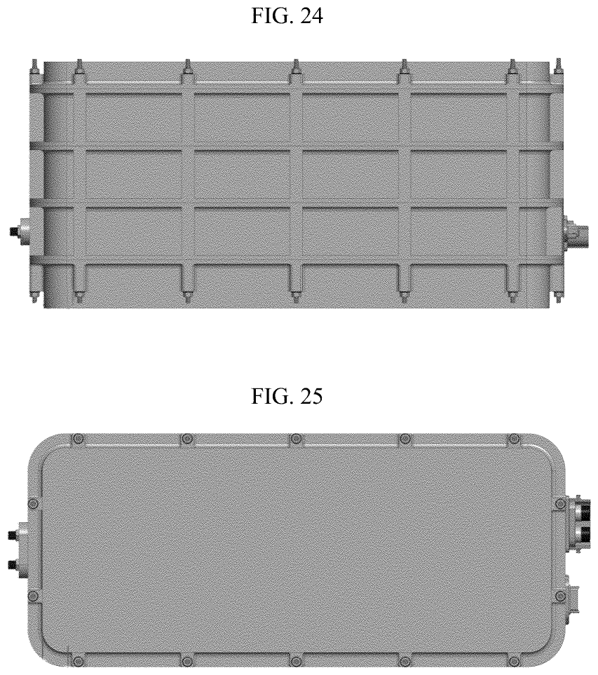

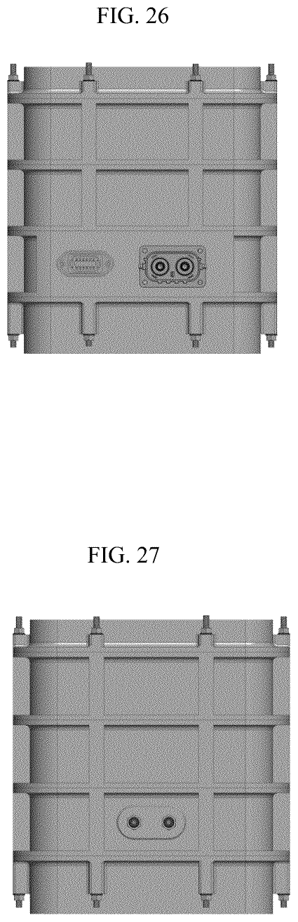

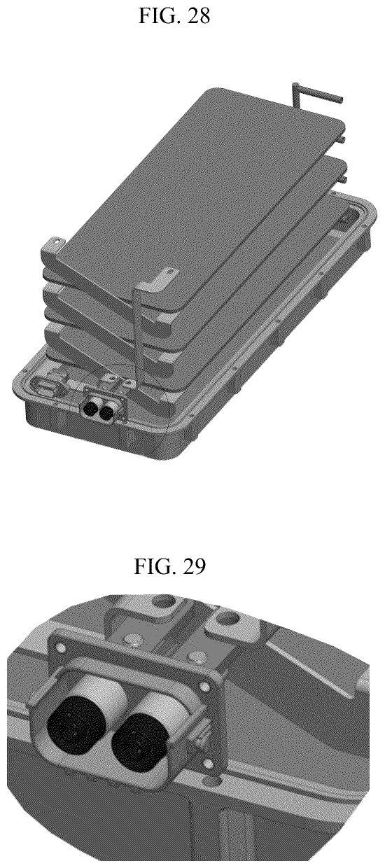

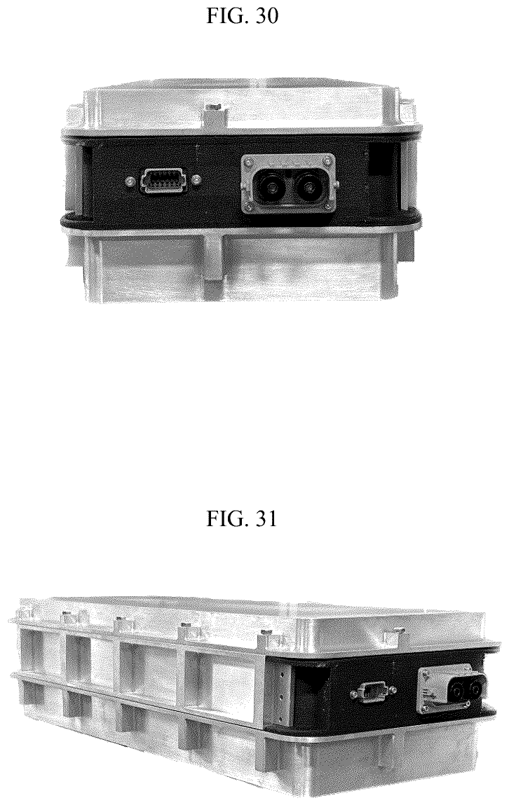

FIG. 11 shows a battery management system (BMS) that includes a drop in replacement battery management card for battery modules, preferably a Tesla 2.5 kw, and stand along master BMS controller. The system can support upwards of 63 battery modules with 16 battery modules as the default configuration application. Each BMS card reads Tesla's 6 battery module string voltages and 2 temperature sensors. There is commandable cell balancing for each 2.5 kw battery module and isolated daisy chain serial interface between each BMS card and master BMS controller. The BMS controller reads all cell voltages and module temperatures from all connected modules. The master BMS controller interfaces with battery charger and master system controller to continuously monitor all voltage and temperature inputs and verify that they are within limits once a second, during charge, discharge and in storage/off mode. An internal safety charger shutdown is included in the event the battery charger fails to shut off. The master BMS continuously monitors all functions and will send an alert notice to ECU if any limits are exceeded in all modes (charge, discharge and in storage/off mode). The BMS modules are compatible with Tesla's pre-existing wiring. FIG. 13 is an example of a Tesla BMS card.

The BMS disclosed herein includes hardware, PCBs and software to replace the OEM card.

The battery management system includes a base unit and a cell pack unit.

The base unit is powered from 12V lead acid battery and has an isolated interface to cell stack units to monitor and balance a typical 400V main EV lithium battery pack. There is J1772 charging cable detection to prevent motor control operation when connected. The base unit enables/disables 400V main EV lithium battery pack charging (J1772 & CAN), includes charging control of 12V lead acid battery from 400V main EV lithium battery pack, and interfaces to third party push button btart or ignition key systems. Solid state relay controls include a high voltage contactor, motor controller, and main accessory power. There are also CAN bus interfaces for interfacing to the touch screen system, EV charger controls (Stealth EV, AEMEV CCU, and related controls), vehicle control unit (AEMEV VCU200/300, O57, etc) high voltage isolation monitor and protection, and a battery charge/discharge current monitor.

The cell pack unit, which is preferably a 74P6S battery module or other brand cell pack, is installed to each 74P6S battery module or cell pack. The unit provides cell voltage measurement, cell balancing, and battery fault monitoring.

The battery management system (BMS) provides improvements over third-party systems as follows. The system replaces the Tesla Model S battery management system card that uses Tesla's proprietary protocols. An isolated daisy chain BMS interface allows usage of existing Tesla BMS connectors. The system eliminates the need to “home run” all cell taps from all battery modules to central location-Orion & AEMEV. The system prevents sub-systems from over discharging both main EV lithium battery and 12V lead acid battery. Most other systems prevent over discharge of main EV lithium battery only. A low current sleep mode minimizes need to disconnect batteries when vehicle is not in use. Each remote BMS cell card reads 6 cell string voltages and 4 temp sensors and will work with most battery cell manufactures and cell configurations.

The isolated daisy chain is based on BQ79606A-Q1 SafeTI Precision Monitor. There is 1 BMS base unit per system, and the daisy chain configuration supports up to 63 cell pack units.

The base unit features include a BQ79606A-Q1 as communications bridge, SPC560B64L7 microcontroller for monitoring and communications, J1772 control pilot and proximity pilot interface for charging control, three CAN interfaces, relay drive outputs to engage contactor and turn on other parts of the vehicle, isolated differential daisy chain communication, which include a two meter cable length between unit with capacitor and choke isolation and optional transformer isolation with longer cable length. The operating voltage range is preferably 7.5-35 VDC. The operating temperature is preferably-40 degrees Celsius to 85 degrees Celsius.

Further features include always on 12V power. Sleep current is approximately 0.79 mA and max sleep time is 342.21 days. Active current is approximately 113 mA. Firmware is developed in C using SPC5Studio with MISRA 2012 compliant drivers and code checking. Operating modes include active, sleep and full shutdown. BMS is in active mode during charging, charge port connected and when vehicle is in operation. BMS goes into sleep mode with 2m periodic wake when not in use. Full shutdown occurs when both 12V and 400V batteries are depleted.

The stack unit features include BQ79606A-Q1, a footprint compatible replacement for Model S BMS, a max balancing current of 150 mA with estimated balancing time of 1.28 hours for 74P6S pack. An external MOSFET can be added to increase balancing current. There is no external power required. The stack unit is powered by connected cells, which are 130 uA in sleep mode and 4.4 mA in active mode. An isolated differential daisy chain communication accommodates up to 2-meter cable length between units The preferred operating temperature is-40 degrees Celsius to 105 degrees Celsius.

There is an electric vehicle power source controller and distribution unit that interfaces from BMS base and supports most EV motors, battery systems and auxiliary battery chargers. It is controlled via direct wire interface and monitored via CAN bus. There are main power high voltage switching with soft start from battery to load(s), three auxiliary high voltage outputs, a battery charger power input and control interface. A smart pre-charge controller matches input voltage and load voltage before allowing the high current contactors to close. There is continuous system isolation check of high voltage components and integrated current shunt for charge control. The power connector includes a safety interlock. If any connector is not mated the interlocks will prevent output to be energized. There is high current high and low side switching. The contactors support continuous load current of 400 A/750 V DC integrated coil economizer circuitry. The contactors are rated for max switching current of 2000 A, max continuous thermal currents of 550 sec 600 A, 90 sec 1000 A.

There are three high voltage auxiliary fused outputs of 30 A each with high side switching. The contactors are rated for continuous current of 50 A 450V, max continuous thermal currents of 150 A for 30 sec, 250 A for 10 sec.

The housing material of the unit is preferably billet aluminum 6061 T6 conversion coated for thermal management and environmental protection. The housing is water resistant at 1 Atmosphere. An O ring seals between layers and there is a built-in pressure relief system. Further construction includes 6061 aluminum and carbon fiber composite for strength and electrical isolation safety. The housing is preferably 15.8 in×9.6 in×5.6 in.

There is a high voltage control box having short circuit protection with a 1000A fuse, a high voltage contactor with pre-charge circuit, which is controlled by BMS base, high voltage connections, including a 400V battery, a 400V battery charger, and high voltage accessories. There is also a battery charge/discharge current monitor, connected via the CAN bus from BMS base, a high voltage isolation monitor, also connected via the CAN Bus from the BMS base. Contactor and Relays operate from 12V.

There are both low and high side contactors for primary 400V circuit and three independent high voltage accessories circuits with contactors and fuses, isolation board in the high voltage box, and all high voltage connectors are high-voltage interlock loop protected.

There is a battery module housing, which is preferably for a Tesla 2.5 kw battery. The modules are stackable, preferably from one to eight. The housing incorporates Tesla's module's alignment and mounting pin for safety. There is an integrated battery module with power, cell data and cooling interface connections. The housing is water resistant at 1 Atmosphere with O ring seals between layers and a built-in pressure relief system. The housing is constructed of billet aluminum 6061 T6 and carbon fiber composite for improved strength over other housings. The housing is configured to be installed in any desired orientation. The connector panels are electrically isolated and made of non-conductive material for safety (greater than 100 k ohms).

Although the above description references particular embodiments, it is to be understood that these embodiments are merely illustrative of the principles and applications of the present disclosure. It is therefore to be understood that numerous modifications may be made to the illustrative embodiments and that other arrangements may be devised and employed without departing from the spirit and scope of the present disclosure.

What is claimed is:

1. An electric vehicle power and control system, comprising:
a. an electronic control unit including a computer having dual CAN bus interfaces and configured to interface with a touch screen monitor having a six degrees of freedom inertial measurement unit;
b. a battery management system including a base unit an a plurality of stack units configured for battery cell balancing and monitoring cell voltage and temperature;
c. a power control and distribution box including bus bars to connect at least one of fuses, contactors, a smart pre-charger, and isolation and current monitors; and
d. a battery module housing system including battery cells integrated with at least one of the battery management system plurality of stack units.

2. The system of claim 1, wherein the computer is an industrial grade computer further including ARM/X64 CPU, 4 GB RAM, 1 TB SSD, USB, WIFI, and Bluetooth.

3. The system of claim 1, wherein the battery management system base unit is connected to the plurality of stack units via a daisy chain wiring harness.

4. The system of claim 3, wherein the battery management system base unit communicates via CAN bus and direct wires with at least one of cooling pumps, the power control and distribution box, a combined charging unit, a charging port, a motor drive system, and a door lock system.

5. The system of claim 1, wherein the power control and distribution box including high voltage bus bars.

6. The system of claim 5, wherein the power control and distribution box include high voltage connectors for a battery pack, motor drive unit, and high voltage accessories of an electric vehicle.

7. The system of claim 1, wherein the battery module housing system battery cells are in a default 74P6S configuration.

8. The system of claim 1, wherein the battery module housing system further includes high voltage bus bar piping for cooling fluid in a billet aluminum and composite carbon fiber chassis.

9. The system of claim 8, wherein the battery module housing system includes one to eight battery modules with a battery management system stack communication harness, the high voltage bus bars and cooling fluid piping being connected in a daisy chain configuration.

10. The system of claim 9, and further including a high voltage connector for positive and negative terminals of the system.

11. The system of claim 10, and further including a low voltage connector for battery management system stack communications.

12. The system of claim 11, and further including two cooling fluid ports for separate intake and outlet.
